(19) United States
(12) Patent Application Publication
(10) Pub. No.: US 2008/0240631 A1
(43) Pub. Date: Oct. 2, 2008

(54) MOVABLE BEARING AND SCREW DRIVE EQUIPPED WITH A MOVABLE BEARING OF THIS TYPE

(76) Inventors: Bernhard Keller, Wasserlosen (DE); Roland Hoherz, Kuetzberg (DE)

Correspondence Address: Striker, Striker & Stenby, 103 East Neck Road, Hungtington, NY, 11743, US

(21) Appl. No.: 12/017,103

(22) Filed: Jan. 21, 2008

(30) Foreign Application Priority Data
Mar. 30, 2007 (DE) 20 2007 004 692.8

(51) Int. Cl. F16C 19/00; F16H 1/24

(52) U.S. Cl. 384/91; 74/424.71

(57) ABSTRACT

A movable bearing for supporting a free end of a threaded spindle of a screw drive, which spindle extends in the direction of a longitudinal axis, has a bearing bush that is accommodated in a bearing housing. The bearing bush has at least one projection protruding outward in the radial direction, which engages in an associated recess of the bearing housing.

### CROSS-REFERENCE TO A RELATED APPLICATION

The invention described and claimed hereinbelow is also described in German Patent Application DE 20 2007 004 692.8 filed on Mar. 30, 2007. This German Patent Application, whose subject matter is incorporated here by reference, provides the basis for a claim of priority of invention under 35 U.S.C. 119(a)-(d).

### BACKGROUND OF THE INVENTION

The invention relates to a movable bearing for supporting a free end of a threaded spindle of a screw drive, which spindle extends in the direction of a longitudinal axis; the movable bearing has a bearing bush that is accommodated in a bearing housing.

A movable bearing of this kind is known, for example, from US 2006/0213298 A1. This movable bearing is embodied in the form of a plain bearing with a slide bushing and is inserted into an associated recess in a housing accommodating the threaded spindle. In this arrangement, it is disadvantageous that the slide bushing can freely rotate in the recess around its longitudinal axis or the longitudinal axis of the threaded spindle.

In addition, the company IGUS markets movable bearings embodied in the form of plain bearings, which are embodied in the form of slotted rings in order to permit their insertion into a through opening of a sheet metal component serving as a bearing housing. In this arrangement as well, the slide bushing is able to rotate freely.

### SUMMARY OF THE INVENTION

By contrast, the object of the present invention is to disclose a movable bearing of the type mentioned at the beginning, which can be placed in its receiving bore in a rotationally fixed way.

This object is attained according to the present invention by means of a movable bearing of the type mentioned at the beginning in which the bearing bush has at least one projection protruding outward in the radial direction, which engages in an associated recess of the bearing housing. The cooperation of the at least one projection and the recess can reliably prevent a rotation of the bearing bush.

In order to essentially be able to completely prevent a rotation of the bearing bush, according to another embodiment, the at least one projection holds the bearing bush in the recess essentially without play in the circumference direction.

In a modification of the invention, the bearing bush can have at least one shoulder protruding outward in the radial direction, which is embodied to rest against the bearing housing in the axial direction. This shoulder serves to stabilize the position of the bearing bush in the bearing housing and can, for example, be embodied in the form of a contact collar.

In order to be able to replace the bearing bush in the event of damage or excessive wear, the bearing bush can be detachably fastened to the housing. To this end, the bearing bush can, for example, have a detent arm, which is embodied to rest against the bearing housing in a direction that acts in the opposite direction from the at least one shoulder. In order to be able to release the detent connection of the detent arm even from the side of the shoulder oriented away from it, an opening can be provided, which remains in the recess next to the at least one projection and which affords access to the detent arm. A tool, for example, can be inserted through this opening so that it engages with the detent arm in order to release its detent connection to the bearing housing.

Alternatively, however, it is also possible for the bearing bush to be injection molded into the bearing housing. The projection that engages with the recess is also formed onto the bearing bush during this injection molding process. According to this embodiment variant, it is in fact not possible to remove the bearing bush from the bearing housing again in a non-destructive fashion. After its removal, however, it is possible to mount in its place a bearing bush of the kind described above, which can be fastened to the bearing bush in a detachable fashion.

In a structurally simple embodiment, the bearing housing can be composed of a mounting plate, for example an angle plate that can be fastened to a base plate. It is also possible, however, for the bearing housing to be comprised of the end plate of a linear module.

According to another aspect, the present invention relates to a screw drive having a threaded spindle that extends in the direction of a longitudinal axis and is supported at its free end in a movable bearing that includes a bearing bush accommodated in a bearing housing; the bearing bush has at least one projection protruding outward in the radial direction, which engages in an associated recess of the bearing housing. For the reasons discussed above, this roller element screw drive also attains the previously stated object.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a movable bearing according to the present invention;

FIG. 2 is a perspective view of the movable bearing according to FIG. 1, viewed from the direction of the arrow II in FIG. 1;

FIG. 3 is a perspective view of a bearing bush of the movable bearing according to the present invention; and

FIG. 4 is a perspective view of another embodiment of a movable bearing according to the present invention.

### DESCRIPTION OF THE PREFERRED EMBODIMENTS

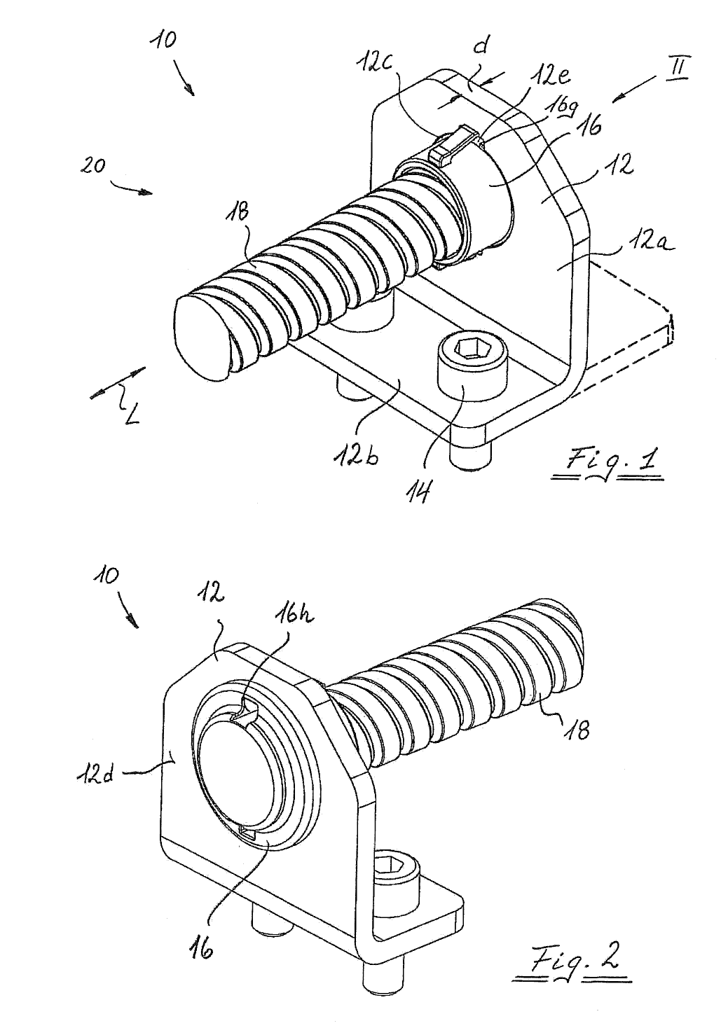

In FIG. 1, a movable bearing according to the present invention is labeled as a whole with the reference numeral 10. The movable bearing 10, which is part of a screw drive 20, in particular a ball screw drive, includes a bearing housing 12, which in the present exemplary embodiment is comprised of an angle plate with a bearing section 12a and a fastening section 12b. The fastening section 12b can be fastened to a larger structural unit, for example a mounting plate, by means of mounting screws 14. The bearing section 12a of the bearing housing 12 has a through opening 12c into which a bearing bush 16 is inserted. The bearing bush 16 serves to support a threaded spindle 18 of the screw drive 20, namely to support the threaded spindle 18 in sliding fashion in its longitudinal direction L and to support the threaded spindle 18 in a plane extending orthogonal to the longitudinal direction L.

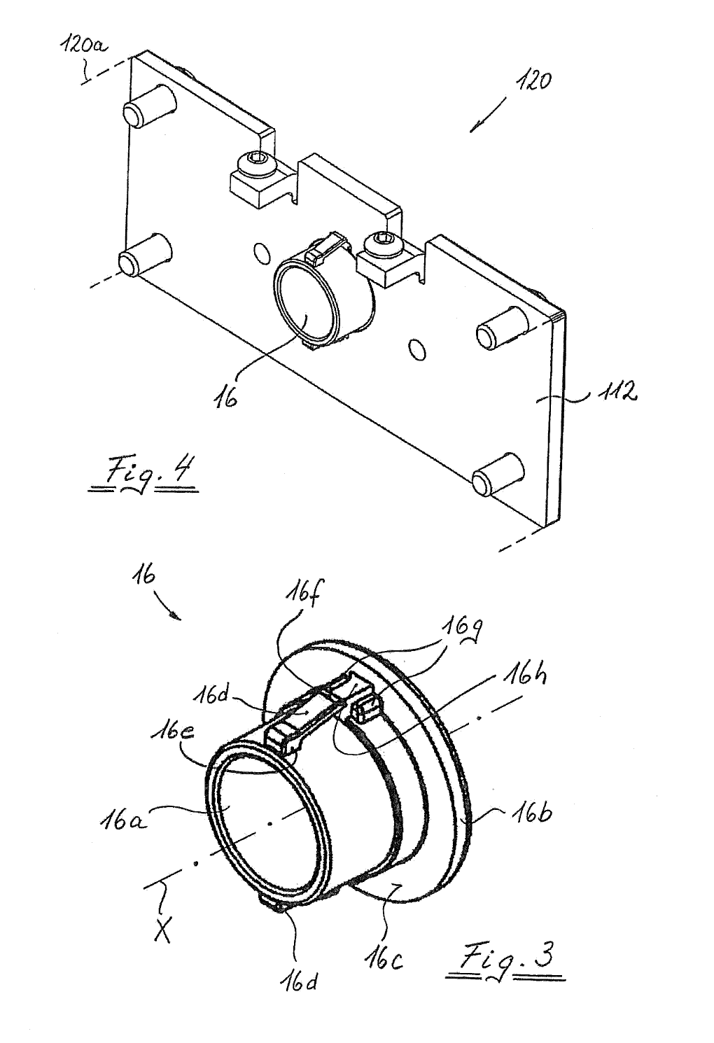

As particularly shown in FIG. 3, the bearing bush 16, which is preferably an injection-molded part made of plastic, has a cylindrical sleeve or bearing section 16a, which encompasses the threaded spindle 18. At one longitudinal end of the bearing section 16a or adjacent to it, an annular shoulder 16b extending in the radial direction is provided, which in the assembled state shown in FIGS. 1 and 2, rests with an annular surface 16c oriented in the longitudinal direction L against a surface 12d (see FIG. 2) of the bearing section 12a of the bearing housing 12.

In the region of its other longitudinal end, the bearing section 16a has two detent arms 16d diametrically opposite from each other, whose radial spacing from the longitudinal central axis X increases as the distance from their connecting points 16e to the sleeve 16a increases. The free end 16f of the detent arms 16d is spaced apart from the annular shoulder 16b by a distance that essentially corresponds to the thickness d of the bearing section 12a of the bearing housing 12 (see FIG. 1).

At two diametrically opposite locations in the rim region of the through opening 12c, two indents or recesses 12e are provided, which permit the detent arms 16d to pass through the through opening 12c. The radial spans of detent arms 16d and recesses 12e in this case are matched to each other so that the detent arms 16d are first pressed inward as they pass through the through opening 12c and then, when the surface 16c of the bearing bush 16 comes into contact with the surface 12d of the bearing housing 12, spring back outward again due to their inherent elasticity and lock the bearing bush 16 to the bearing housing 12 in detent fashion. In this state, two ribs 16g protruding radially out from the bearing bush are situated in the recess 12e and rest essentially without play against its side walls in the circumference direction around the axis X. In this way, the bearing bush 16 is secured against an unintended rotation in the bearing housing 12.

In order to be able to remove the bearing bush 16 from the bearing housing 112 again when the bearing bush 16 is not freely accessible on the side of the detent arms 16d, an opening 16h situated in the annular shoulder 16b and aligned with the detent arm 16d is provided, through which a tool can be inserted in order to afford access to the detent arm 16d. The ribs 16g are situated on the sides of the contact surface 16c of the annular shoulder 16b, on both sides of the opening 16h. This is the case, for example, in the embodiment shown in FIG. 4 in which the bearing housing is embodied in the form of an end plate 112 of a linear module 120 whose module housing 120a is only depicted with dashed lines.

It should also be noted that the fastening section 12b of the angle plate 12 does not necessarily have to extend in the same direction as the threaded spindle 18. Instead, it is also possible for it to extend away from it, as depicted with dashed lines in FIG. 1. It is also possible for a plurality of fastening sections to be provided, of which at least one extends in the direction of the threaded spindle 18, while at least one other extends in the opposite direction.

It will be understood that each of the elements described above, or two or more together, may also find a useful application in other types of constructions differing from the type described above.

While the invention has been illustrated and described as embodied in a movable bearing and screw drive equipped with a movable bearing of this type, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A movable bearing for supporting a free end of a threaded spindle of a screw drive with the spindle extending in a direction of a longitudinal axis, the movable bearing comprising a bearing housing; a bearing bush accommodated in said bearing housing, said bearing bush having at least one projection protruding outward in a radial direction, and said bearing housing having an associated recess in which said at least one projection engages.

2. A movable bearing as defined in claim 1, wherein said at least one projection is configured so that it holds said bearing bush in said recess essentially without play in a circumferential direction.

3. A movable bearing as defined in claim 1, wherein said bearing bush has at least one shoulder protruding outward in the radial direction and configured to rest against said bearing housing in an axial direction.

4. A movable bearing as defined in claim 1, wherein said bearing bush is fastenable to said housing in a detachable fashion.

5. A movable bearing as defined in claim 3, wherein said bearing bush has at least one detent arm which is configured to rest against said bearing housing in a direction that acts in an opposite direction from said at least one shoulder.

6. A movable bearing as defined in claim 5, wherein said detent arm is accessible from a side of said shoulder oriented away from it through an opening remaining in said recess next to said at least one projection.

7. A movable bearing as defined in claim 1, wherein said bearing bush is configured as a bearing bush injection molded into said bearing housing.

8. A movable bearing as defined in claim 8, wherein said bearing bush is configured as a mounting plate that is fastenable to a base plate.

9. A movable bearing as defined in claim 8, wherein said mounting plate is configured as an angle plate.

10. A movable bearing as defined in claim 1, wherein said bearing housing is comprised of an end plate of a liner module.

11. A screw drive, comprising a threaded spindle extending in a direction of a longitudinal axis and having a free end; and a movable bearing in which said free end of said threaded spindle is supported said movable bearing including a bearing housing; a bearing bush, and accommodated in said bearing housing, said bearing bush having at least one projection protruding outward in a radial direction, and said bearing housing having an associated recess in which said at least one projection engages.

12. A screw drive as defined in claim 11, wherein said screw drive is configured as a ball screw drive.
